(19) United States
(12) Patent Application Publication
(10) Pub. No.: US 2025/0296806 A1
(43) Pub. Date: Sep. 25, 2025

(54) METHOD FOR DETERMINING TORQUE CONSTANT OF HOISTING MOTOR OF ELEVATOR, ELEVATOR CONTROL UNIT, ELEVATOR SYSTEM, AND COMPUTER-READABLE MEMORY MEDIUM

(71) Applicant: KONE CORPORATION, Helsinki (FI)

(72) Inventors: Tapio TYNI, Helsinki (FI); Pekka PERÄLÄ, Helsinki (FI); Toni TUKIA, Helsinki (FI); Janne SALOMÄKI, Helsinki (FI)

(73) Assignee: KONE CORPORATION, Helsinki (FI)

(21) Appl. No.: 19/230,768

(22) Filed: Jun. 6, 2025

Related U.S. Application Data
(63) Continuation of application No. PCT/FI2023/050034, filed on Jan. 16, 2023.

(51) Int. Cl. B66B 1/30; B66B 1/34

(52) U.S. Cl. CPC B66B 1/30; B66B 1/3476

(57) ABSTRACT

A method for determining a torque constant of a hoisting motor (302) of an elevator system (300). The method comprises performing (110) a roundtrip in an elevator shaft (340) by an elevator car (310) by utilizing the hoisting motor (302), wherein the roundtrip comprises a constant speed portion (21) in a first direction and a constant speed portion (22) in a opposite second direction. The method comprises determining (120) a motor current of the hoisting motor (302), such as recording samples thereof, during at least the constant speed portions, determining (130) a mean value of the motor current in the constant speed portions (21, 22), and determining (140) the torque constant based on the mean value, an elevator balance, and one or more mechanical parameters related to a force transmission between the hoisting motor (302) and the elevator car (310). An elevator system (300), an elevator control unit (1000), and a computer-readable memory medium are also disclosed.

### FIELD OF THE INVENTION

The present invention relates in general to elevator systems and hoisting motors thereof. In particular, however, not exclusively, the present invention concerns methods, control units, and computer-readable memory medium used in elevator systems for determining a torque constant of a hoisting motor.

### BACKGROUND

Elevator car is transferred in elevator shaft through landings by means of an elevator hoisting motor, such as a permanent magnet motor. Movement of the car is controlled by supplying current to the hoisting motor through a frequency converter.

Motor current is adjusted by the frequency converter, to control movement of the car. High ride quality is required in modern elevators. Movement of the car should be smooth and comfortable for elevator passengers.

Smooth and comfortable ride requires that control unit of the frequency converter has as accurate as possible motor control parameters. On the other hand, control parameters are commonly determined for a certain motor type, which means there may be tolerances and deviation between individual hoisting motors.

Normally in known elevator machinery, a nominal torque constant, that is a KTC-value, is printed on the motor plate and is defined during the motor type tests. Currently, the drive units do not use the provided KTC value, as it is found to be too inaccurate. Instead, a substitute is calculated from the nominal current and power values, which in many cases lead even more inaccurate estimations for the KTC parameter. KTC is an important parameter for movement control of an elevator car as it tells how much motor current is needed for generating certain amount of motor torque.

### SUMMARY

An objective of the present invention is to provide a method for determining a torque constant of a hoisting motor of an elevator, an elevator control unit, an elevator system, and a computer-readable memory medium. Another objective of the present invention is that the method, the elevator control unit, the elevator system, and the computer-readable memory medium a solution for determining an elevator and hoisting motor specific torque constant which improves accuracy and eliminates possible errors in the parameter determination process.

The objectives of the invention are reached by a method for determining a torque constant of a hoisting motor of an elevator, an elevator control unit, an elevator system, and a computer-readable memory medium as defined by the respective independent claims.

According to a first aspect, a method for determining a torque constant of a hoisting motor of an elevator system is provided. The method comprises:
performing a roundtrip in an elevator shaft by an elevator car by utilizing the hoisting motor, wherein the roundtrip comprises a constant speed portion in a first direction and a constant speed portion in a opposite second direction,
determining a motor current of the hoisting motor, such as recording samples thereof, during at least the constant speed portions,
determining a mean value of the motor current in the constant speed portions, and
determining the torque constant based on the mean value, an elevator balance, and one or more mechanical parameters related to a force transmission between the hoisting motor and the elevator car.

The roundtrip may include only a part of the elevator shaft in the longitudinal direction thereof with an empty load, or the roundtrip may be a ride between the bottom floor and the top floor with an empty load, that is cover the whole elevator shaft.

Furthermore, the elevator balance refers to a measure of imbalance between the elevator car and its counterweight, especially at a reference point, such as a middle point of the elevator shaft. As a non-limiting example, if the empty elevator car is perfectly balanced with its counterweight (being connected to each other by force transmission elements/devices) at the reference point, the elevator balance would be zero. This would mean that the hoisting motor would draw the same amount of electric power regardless of whether the empty elevator car is moved in the first or the opposite second direction from the reference point, such as the middle point of the shaft.

Regarding the constant speed portions, in them, the elevator car may preferably be arranged to move past the middle point of the elevator shaft. Thus, the roundtrip should at least cover the section of the elevator shaft comprising the middle point, regardless of whether the roundtrip includes only a part of the shaft or the whole shaft.

Alternatively or in addition, in both of the constant speed portions, that is in both directions, the elevator car may be arranged to move in the same section of the elevator shaft. Thus, the start and end points of the constant speed regions are the same positions relative to the shaft in both cases, when moving to the first or to the opposite second direction.

In various embodiments, the one or more mechanical parameters may include at least a traction sheave radius and/or an elevator roping ratio. As understood, these parameters affect the overall balance condition related to the elevator car and its counterweight, and may vary from one elevator system to another.

In some preferable embodiments, the determining the torque constant is based on the following equation:

$$K T C = Rts \cdot \vert MB \vert \cdot g / ( I m , mean \cdot Rrope ) ,$$

where Rts is the traction sheave radius, MB the elevator balance, g the gravitational acceleration, Im,mean the mean value of the motor current, and Rrope the elevator roping ratio.

The roping ratio may refer to the amount of hoisting rope that the hoisting motor has to move in order to raise the elevator car by a desired distance.

In various embodiments, the mean value of motor current Im, mean may be determined based on the following equation:

$$Im , mean = \frac{1}{K} {\sum }_{n = 1}^{K} Im , n ,$$

where K is a number of samples of the motor current during the constant speed portions, and Im,n is a motor current sample.

In various embodiments, information about the elevator balance may be pre-defined prior to, or received or obtained during performing of a test run or even the roundtrip. For example, the elevator balance may have been determined during a previous test run or an elevator commissioning phase, and then stored into the memory to be used in an embodiment of the present invention. The previous test run or commissioning phase may have included moving the elevator car in the elevator shaft, such as with a constant speed, even similarly as during the roundtrip.

Alternatively, in various embodiments, the method may comprise determining the elevator balance based on data collected during the roundtrip. For example, the method may comprise, prior to the determination of the torque constant but during or after the roundtrip, determining the elevator balance based on at least a difference in electric power of the hoisting motor between the constant speed portions, preferably at or on average around the middle point of the elevator shaft.

In some embodiments, the elevator balance may be determined based on the following equation:

$$M B = ( Pme , mid , up - Pme , mid , down ) / ( 2 \cdot g \cdot v\_cs ) ,$$

where Pme,mid,up is electric power of the hoisting motor during the constant speed portion in the first direction, Pme,mid,down is electric power of the hoisting motor during the constant speed portion in the second direction, g is the gravitational acceleration, and v_cs an absolute value of speed of the elevator car at the constant speed regions, which may be the same or differ with respect to the nominal speed of the elevator car. Preferably, the electric power values are being determined at or around the middle point of the shaft when the elevator car moves at a constant speed.

According to a second aspect, an elevator control unit is provided. The elevator control unit comprises at least a processing unit and a memory, such as a processor and a non-transitory/volatile memory medium, and data receiving unit for receiving data including information about a motor current of a hoisting motor. The elevator control unit is configured to perform a roundtrip in an elevator shaft by an elevator car by utilizing the hoisting motor, wherein the roundtrip comprises a constant speed portion in a first direction and a constant speed portion in a opposite second direction, and to determine a motor current of the hoisting motor, such as recording samples thereof, during at least the constant speed portions. Furthermore, the elevator control unit is configured to determine a mean value of the motor current in the constant speed portions, and to determine the torque constant based on the mean value, an elevator balance, and one or more mechanical parameters related to a force transmission between the hoisting motor and the elevator car.

The one or more mechanical parameters may include at least a traction sheave radius and/or an elevator roping ratio.

Said determining of the torque constant may be based on the following equation:

$$KTC = Rts \cdot \vert MB \vert \cdot g / ( I m , mean \cdot Rrope ) ,$$

where Rts is the traction sheave radius, MB the elevator balance, g the gravitational acceleration, Im,mean the mean value of the motor current, and Rrope the elevator roping ratio.

In various embodiments, the elevator control unit may be configured, prior to the determination of the torque constant, to determine the elevator balance based on at least a difference in electric power of the hoisting motor between the constant speed portions, preferably at or on average around the middle point of the elevator shaft.

According to a third aspect, an elevator system is provided. The elevator system comprises an elevator car movable in an elevator shaft by a hoisting motor, and an elevator control unit in accordance with the second aspect, that is with one or more embodiments thereof.

According to a fourth aspect, there is provided a computer-readable memory medium, such as a non-transitory memory medium or device, comprising instructions which, when executed by a processing unit, such as including one or several processors, cause the processing unit to carry out the method in accordance with the first aspect, that is one or more embodiments thereof.

The present invention provides a method for determining a torque constant of a hoisting motor of an elevator, an elevator control unit, an elevator system, and a computer-readable memory medium. The present invention provides advantages over known solutions in that an elevator or hoisting motor specific torque constant can be determined easily and accurately. The accurate torque constant is important and needed for many purposes, such as in controlling the motor, including motion control, torque assisted brake test, parameter estimations, energy calculations, etc.

Various other advantages will become clear to a skilled person based on the following detailed description.

The expression “a plurality of” may refer to any positive integer starting from two (2), that is being two, at least two, three, at least three, etc.

The terms “first”, “second” and “third” are herein used to distinguish one element from other element, and not to specially prioritize or order them, if not otherwise explicitly stated.

The exemplary embodiments of the present invention presented herein are not to be interpreted to pose limitations to the applicability of the appended claims. The verb “to comprise” is used herein as an open limitation that does not exclude the existence of also unrecited features. The features recited in appended claims are mutually freely combinable unless otherwise explicitly stated.

The novel features which are considered as characteristic of the present invention are set forth in particular in the appended claims. The present invention itself, however, both as to its construction and its method of operation, together with additional objectives and advantages thereof, will be best understood from the following description of specific embodiments when read in connection with the accompanying drawings.

### BRIEF DESCRIPTION OF FIGURES

Some embodiments of the invention are illustrated by way of example, and not by way of limitation, in the figures of the accompanying drawings.

FIG. 1 shows a flow diagram of a method according to an embodiment of the present invention.

FIG. 2 illustrates schematically characteristics of a roundtrip in connection with a method according to an embodiment of the present invention.

FIG. 3 illustrates schematically an elevator system according to an embodiment of the present invention.

### DETAILED DESCRIPTION OF SOME EMBODIMENTS

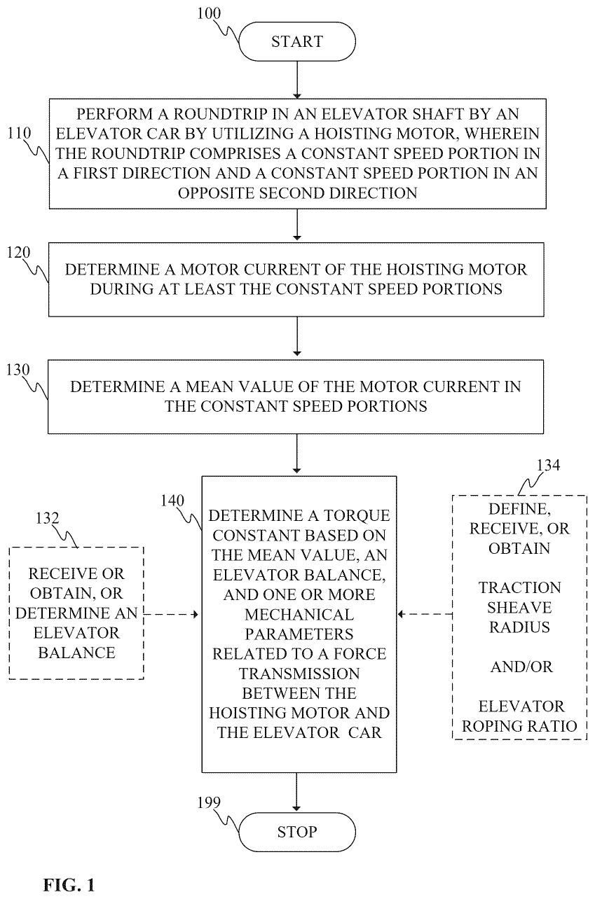

FIG. 1 shows a flow diagram of a method according to an embodiment of the present invention. Item, or method step, 100 refers to a start-up phase of the method. Suitable equipment and components may be obtained, and systems assembled and configured for operation. This may mean manufacturing an elevator system and setting it up, or the elevator system may be ready for commissioning and/or test runs. Alternatively, the elevator may have been used already but set (temporarily) into a maintenance mode or the like.

In various embodiments, the elevator may be configured to be in a maintenance mode prior to performing item 110. The maintenance mode differs from a normal operation mode in which the elevator car is arranged to serve landing floors based on elevator car calls. The maintenance mode may be initialized locally or remotely, or even automatically by an elevator control unit when certain conditions for maintenance mode are fulfilled.

In addition, optionally, the method may comprise verifying that the elevator car is empty prior to performing item 110. The verifying may include visual inspection by a maintenance person and/or utilization of a sensor, such as a sensor for determining weight of the car or the loading inside the car, or an optical sensor for determining that the elevator is empty by monitoring the inner space of the car.

Item, or method step, 110 refers to performing a roundtrip in an elevator shaft by an elevator car by utilizing the hoisting motor, wherein the roundtrip comprises a constant speed portion in a first direction and a constant speed portion in a opposite second direction. The first and second directions are, preferably, vertical directions. The first direction may be, for example, upwards and the second direction downwards.

In the constant speed portions, the elevator car may be arranged to move past a middle point of the elevator shaft. In some embodiments, in the constant speed portions, the elevator car is arranged to move in the same section of the elevator shaft, thus also including the middle point.

The roundtrip may include only a part of the elevator shaft in the longitudinal direction thereof with an empty load, or the roundtrip may be a ride between the bottom floor and the top floor with an empty load, that is cover the whole elevator shaft.

Alternatively or in addition, in both of the constant speed portions, that is in both directions, the elevator car may be arranged to move in the same section of the elevator shaft. Thus, the start and end points of the constant speed regions are the same positions relative to the shaft in both cases, when moving to the first or to the opposite second direction.

Item, or method step, 120 refers to determining a motor current of the hoisting motor, such as recording samples thereof, during at least the constant speed portions. The motor current may be determined by an electric converter (or a current sensor thereof) arranged to operate or drive the motor, or by a dedicated current sensor in connection with the elevator control unit, for instance.

Item, or method step, 130 refers to determining a mean value of the motor current in the constant speed portions. The motor current values recorded on both constant speed portions should be taken into account. For example, the mean value of motor current may be determined based on the following equation:

$$Im , mean = \frac{1}{K} {\sum }_{n = 1}^{K} Im , n ,$$

where K is a number of samples of the motor current Im,n during both of the constant speed portions.

Item, or method step, 140 refers to determining the torque constant based on the mean value, an elevator balance, and one or more mechanical parameters related to a force transmission between the hoisting motor and the elevator car.

The elevator balance may refer to a measure of imbalance between the elevator car and its counterweight, especially at a reference point, such as a middle point of the elevator shaft. As a non-limiting example, if the empty elevator car is perfectly balanced with its counterweight (being connected to each other by force transmission elements/devices) at the reference point, the elevator balance would be zero. This would mean that the hoisting motor would draw the same amount of electric power regardless of whether the empty elevator car is moved in the first or the opposite second direction from the reference point, such as the middle point of the shaft.

In various embodiments, the method may comprise, at item 132, determining the elevator balance prior to item 140. For example, it may be received or obtained as pre-defined in the system, or it may be determined based on data collected during a separate, prior test run or during the roundtrip at item 110.

In the method, the characteristics of the mechanical coupling between the hoisting motor and the elevator car are, preferably, taken into account. As understandable, in different elevators, force applied by the hoisting motor to move the elevator car causes different resulting movement of the car, depending on the mechanical parameters of the specific elevator etc.

In some embodiments, the mechanical parameters may include at least a traction sheave radius Rts and an elevator roping ratio Rrope. These may, optionally, be defined, obtained, or received at item 134 in FIG. 1, prior to determining the torque constant.

In some embodiments, said determining the torque constant may be based on the following equation:

$$KTC = Rts \cdot \vert MB \vert \cdot g / ( I m , mean \cdot Rrope ) ,$$

where Rts is the traction sheave radius, MB the elevator balance, g the gravitational acceleration, Im,mean the mean value of the motor current, and Rrope the elevator roping ratio.

Method execution may be stopped at item 199. The determined torque constant may be inputted or stored into memory and optionally used in controlling of the operation of the hoisting motor, such as by an electric converter which may be a frequency converter. As mentioned before, the determined torque constant may be used for various purposes.

In some embodiments, the method may comprise, prior to the determination of the torque constant, determining the elevator balance based on at least a difference in electric power of the hoisting motor between the constant speed portions, preferably at or on average around the middle point of the elevator shaft.

For example, the elevator balance may determined based on the following equation:

$$MB = ( Pme , mid , up - Pme , mid , down ) / ( 2 \cdot g \cdot v\_cs ) ,$$

where Pme,mid,up is electric power of the hoisting motor during the constant speed portion in the first direction, Pme,mid,down is electric power of the hoisting motor during the constant speed portion in the second direction, g is the gravitational acceleration, and v_cs an absolute value of the speed of the elevator car at the constant speed regions.

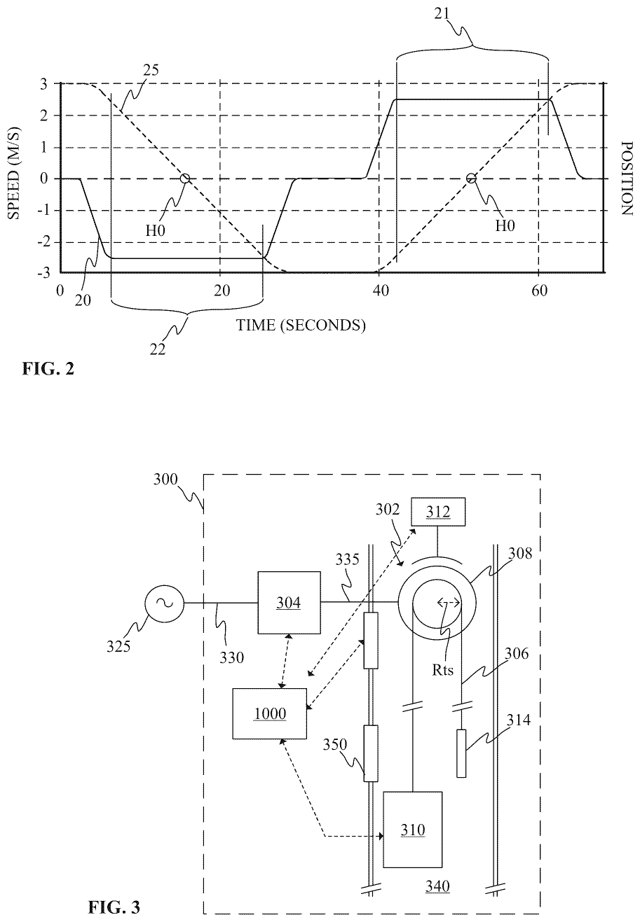

FIG. 2 illustrates schematically characteristics of a roundtrip in connection with a method according to an embodiment of the present invention. FIG. 2 illustrates the roundtrip as a graph, on the horizontal axis of which is time (in seconds), on the vertical axis on the left is the speed of the elevator car (in meters per second), and on the vertical axis on the right is the position of the elevator car in the elevator shaft. The units of the position may be meters, such as in relation to the bottommost floor (being zero), or floor numbers or the like.

In FIG. 2, the speed curve is marked with reference sign 20. On the speed curve 20, two constant speed portions 21, 22 are indicated to be between vertical lines. The position curve is marked with reference sign 25. Positive values for speed indicate that the elevator car is moving into the first direction, preferably, upwards. Negative values for speed indicate that the elevator car is moving into the opposite second direction, preferably downwards.

Marked with circles on the position curve 25 are the middle points H0 of the elevator shaft. In this graph, the middle point of the shaft coincides with zero speed as visible in the graph. This is merely a choice to make the graph as easily readable as possible.

In this particular example, an embodiment is described in which the elevator car covers substantially the same section of the elevator shaft during the two constant speed portions 21, 22 as becomes clear when looking at the portions of the position curve 25 defined by the vertical lines also defining the constant speed portions 21, 22 on the speed curve 20. Furthermore, the middle point H0 of the elevator shaft is, although doesn't necessarily have to be, substantially in the center of the sections of the shaft covered by the elevator car during the constant speed portions 21, 22.

Furthermore, in FIG. 2, an example is illustrated where the elevator car is moved from the bottommost floor (coinciding with “−3” on the left vertical axis) to the topmost floor (coinciding with “3” on the right vertical axis). In some embodiments, the height of the shaft may be in the range of 5 to 100 meters, preferably from 10 to 80 meters, such as about 60 meters.

As can further be seen in FIG. 2, during the roundtrip, the elevator car may additionally be stopped for some time(s) (the speed being zero) at some portions of the roundtrip, such as at the extreme points thereof (for example, at the bottommost and the topmost floors). These stopping portions do not qualify as the constant speed portions, since during the constant speed portions, an absolute value of the speed of the elevator car v_cs must be higher than zero.

FIG. 3 illustrates schematically an elevator system 300 according to an embodiment of the present invention. The elevator system 300 comprises a hoisting motor 302, such as a permanent magnet electric motor, for moving an elevator car 310 comprised in the elevator system 300. The elevator car 310 may be mechanically coupled to the electric motor 302, preferably, by a hoisting rope 306. The operation of the electric motor 302 may be controlled by an electric converter 304 such as a frequency converter or an inverter. The elevator car 310 is moved in the elevator shaft 340 in the normal operation mode so as to serve landing floors 350.

The hoisting rope 306 may comprise, for example, steel or carbon fibers. The term ‘hoisting rope’ does not limit the form of the element anyhow. For example, the hoisting rope 306 may be implemented as a rope or a belt.

The hoisting motor 302 may be arranged in mechanical coupling with a traction sheave 308. Furthermore, the hoisting rope 304 may be arranged to run via the traction sheave 308 in order for the hoisting motor 302 to be able to move the elevator car 310 coupled to the hoisting rope 302. Still further, being connected to the hoisting rope 302, may preferably be a counterweight 314 for the elevator car 310. Although shown in FIG. 3 that the hoisting rope 306 would be attached from one end to the elevator car 310 and from the opposite end to the counterweight 314, and then simply running via the traction sheave 308, in practice, the hoisting rope 306 may run via one or several other sheaves and components, as known to a skilled person in the art. Thus, depending how the hoisting rope 306 is arranged to run, for example, past how many sheaves and how such configuration is designed and arranged, the roping ratio may be different from one elevator system 300 to another.

The elevator system 300 may comprise an elevator control unit 1000 for controlling the operation of the elevator system 300, such as various devices thereof. The elevator control unit 1000 may be a separate device or may be comprised in the other components of the elevator system 300 such as in or as a part of the electric converter 304. In various embodiments, the elevator control unit 1000 comprises the electric converter 304.

The elevator control unit 1000 may also be implemented in a distributed manner so that, e.g., one portion of the elevator control unit 1000 may be comprised in the electric converter 304 and another portion in the elevator car 310, for instance. The elevator control unit 1000 may also be arranged in distributed manner at more than two locations or in more than two devices. As can be seen in FIG. 3, the elevator control unit 1000 may be arranged to at least communicate (examples of such connections being shown with dashed two-headed arrows) with various devices of the elevator system 300.

The elevator system 300 may comprise an elevator brake arrangement 312 comprising an elevator brake, preferably, an electromechanical elevator brake.

Other elements, shown in FIG. 3 are a main electrical power supply 325 such as a three- or single-phase electrical power grid, an electrical connection 330 between the power supply 325 and the electric converter 304, another electrical connection 335 between the electric converter 304 and the electric motor 302.

1. A method for determining a torque constant of a hoisting motor of an elevator system, the method comprising:
performing a roundtrip in an elevator shaft by an elevator car by utilizing the hoisting motor, wherein the roundtrip comprises a constant speed portion in a first direction and a constant speed portion in a opposite second direction,
determining a motor current of the hoisting motor, such as recording samples thereof, during at least the constant speed portions,
determining a mean value of the motor current in the constant speed portions, and
determining the torque constant based on the mean value, an elevator balance, and one or more mechanical parameters related to a force transmission between the hoisting motor and the elevator car.

2. The method of claim 1, wherein, in the constant speed portions, the elevator car is arranged to move past a middle point of the elevator shaft.

3. The method of claim 2, wherein, in the constant speed portions, the elevator car is arranged to move in the same section of the elevator shaft.

4. The method of claim 1, wherein the mechanical parameters include at least a traction sheave radius and an elevator roping ratio.

5. The method of claim 1, wherein the elevator balance is a measure of imbalance between the elevator car and its counterweight.

6. The method of claim 1, wherein said determining the torque constant, that is KTC, is based on the following equation:
$$KTC = Rts \cdot \vert MB \vert \cdot g / ( I m , mean \cdot Rrope ) ,$$
where Rts is the traction sheave radius, MB the elevator balance, g the gravitational acceleration, Im,mean the mean value of the motor current, and Rrope the elevator roping ratio.

7. The method of claim 1, wherein the mean value of motor current, that is Im,mean, is determined based on the following equation:
$$Im , mean = \frac{1}{K} {\sum }_{n = 1}^{K} Im , n ,$$
where K is a number of samples of the motor current, that is Im,n, during the constant speed portions.

8. The method of claim 1, comprising, prior to the determination of the torque constant, determining the elevator balance based on at least a difference in electric power of the hoisting motor between the constant speed portions, preferably at or on average around the middle point of the elevator shaft.

9. The method of claim 8, wherein the elevator balance, that is MB, is determined based on the following equation:
$$MB = ( Pme , mid , up - Pme , mid , down ) / ( 2 \cdot g \cdot v\_cs ) ,$$
where Pme,mid,up is electric power of the hoisting motor during the constant speed portion in the first direction, Pme,mid,down is electric power of the hoisting motor during the constant speed portion in the second direction, g is the gravitational acceleration, and v_cs an absolute value of speed of the elevator car at the constant speed regions.

10. An elevator control unit comprising at least a processing unit and a memory, such as a processor and a non-transitory memory medium, and data receiving unit for receiving data including information about a motor current of a hoisting motor, and wherein the elevator control unit is configured to:
perform a roundtrip in an elevator shaft by an elevator car by utilizing the hoisting motor, wherein the roundtrip comprises a constant speed portion in a first direction and a constant speed portion in a opposite second direction,
determine a motor current of the hoisting motor, such as recording samples thereof, during at least the constant speed portions, determine a mean value of the motor current in the constant speed portions, and
determine the torque constant based on the mean value, an elevator balance, and one or more mechanical parameters related to a force transmission between the hoisting motor and the elevator car.

11. The elevator control unit of claim 10, wherein the mechanical parameters include at least a traction sheave radius and an elevator roping ratio.

12. The elevator control unit of claim 11, wherein said determining the torque constant, that is KTC, is based on the following equation:
$$KTC = Rts \cdot \vert MB \vert \cdot g / ( I m , mean \cdot Rrope ) ,$$
where Rts is the traction sheave radius, MB the elevator balance, g the gravitational acceleration, Im, mean the mean value of the motor current, and the elevator roping ratio.

13. The elevator control unit of claim 10, configured, prior to the determination of the torque constant, to determine the elevator balance based on at least a difference in electric power of the hoisting motor between the constant speed portions, preferably at or on average around the middle point of the elevator shaft.

14. An elevator system, comprising:
an elevator car movable in an elevator shaft by a hoisting motor, and
an elevator control unit of claim 10.

15. A non-transitory computer-readable memory medium comprising instructions which, when executed by a processing unit, such as including one or several processors, cause the processing unit to carry out the method of claim 1.

16. The method of claim 2, wherein the mechanical parameters include at least a traction sheave radius and an elevator roping ratio.

17. The method of claim 3, wherein the mechanical parameters include at least a traction sheave radius and an elevator roping ratio.

18. The method of claim 2, wherein the elevator balance is a measure of imbalance between the elevator car and its counterweight.

19. The method of claim 3, wherein the elevator balance is a measure of imbalance between the elevator car and its counterweight.

20. The method of claim 4, wherein the elevator balance is a measure of imbalance between the elevator car and its counterweight.
